(19) United States
(12) Patent Application Publication
(10) Pub. No.: US 2002/0124390 A1
(43) Pub. Date: Sep. 12, 2002

(54) Method for adjusting the length of an output rod in a power brake booster

(75) Inventors: Michel J. Vermoesen, Miamisburg, OH (US); Patrick T. Maclellan, Springboro, OH (US)

Correspondence Address: DELPHI TECHNOLOGIES, INC., Legal Staff, Mail Code: 482-204-450, P.O. Box 5052, 1450 W. Long Lake, Troy, MI, 48098, US

(73) Assignee: DELPHI TECHNOLOGIES INC.

(21) Appl. No.: 10/091,853

(22) Filed: Mar. 6, 2002

Related U.S. Application Data
(60) Provisional application No. 60/273,722, filed on Mar. 6, 2001.

(51) Int. Cl. B23P 19/00

(52) U.S. Cl. 29/700

(57) ABSTRACT

A method of positioning a cap on an output rod of a power booster comprises holding the cap in a fixed position, inserting a shaft of the cap into a bore in the output rod, and fixing the cap relative to the output rod.

### CROSS-REFERENCE TO RELATED APPLICATIONS

This application claims the benefit of U.S. Provision Patent Application Serial No. 60/273,722, and is also related to U.S. patent application Ser. No. 10/036,879 filed Dec. 26, 2001.

### TECHNICAL FIELD OF THE INVENTION

The invention relates to vacuum boosters for motor vehicles. More particularly, the present invention relates to a method for adjusting the length of an output rod in a vacuum booster or power brake.

### BACKGROUND OF THE INVENTION

Power boosters operating on a pressure differential, such as exists between the engine intake manifold of a vehicle and the atmosphere, are well known devices. In the case of a single stage power booster, a shell-like housing typically encloses at least one variable pressure chamber that is separated from a vacuum chamber by a diaphragm and its supporting wall. The diaphragm and supporting wall are axially movable relative to the housing under variable pressure conditions. In order to achieve an increased boost effect, tandem power boosters have the interior of the housing subdivided by a housing divider wall separating a secondary variable pressure and vacuum chamber combination from the primary chamber pair. In all cases, a power piston is urged to move axially by the diaphragm(s) and actuates an output rod for operating the vehicle brakes through an engaged hydraulic master cylinder.

The master cylinder typically has bypass holes that must be covered, normally by primary and secondary seals, in order to develop hydraulic pressure in the brake line. To accommodate dimensional tolerances, the seals are usually situated some distance from the bypass holes. This distance gives rise to some travel in the vehicle brake pedal, which may be magnified by the remainder of the power booster.

### SUMMARY OF THE INVENTION

The present invention is a method of positioning a cap on an output rod of a power booster. The method comprises holding the cap in a fixed position, inserting a shaft of the cap into a bore in the output rod, and fixing the cap relative to the output rod.

Accordingly, it is an object of the present invention to provide a unique method of setting a longitudinal dimension on a vacuum booster.

Another object of the present invention is to provide a power booster of the type described above that reduces travel loss while the assembly is still in the assembly plant.

Still another object of the present invention is to provide a power booster of the type described above that minimizes or avoids any need to adjust the end fitting of the output rod before attachment to the master cylinder.

These and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

The present invention will now be described, by way of example, with reference to the accompanying drawings, in which:

FIG. 1 is a perspective view of a power booster according to the present invention cut away to expose the interior of the power booster;

FIG. 2 is a cross-sectional view of a portion of the power booster and a machine for implementing a method according to the present invention.

### DETAILED DESCRIPTION OF THE PRESENTLY PREFERRED EMBODIMENT

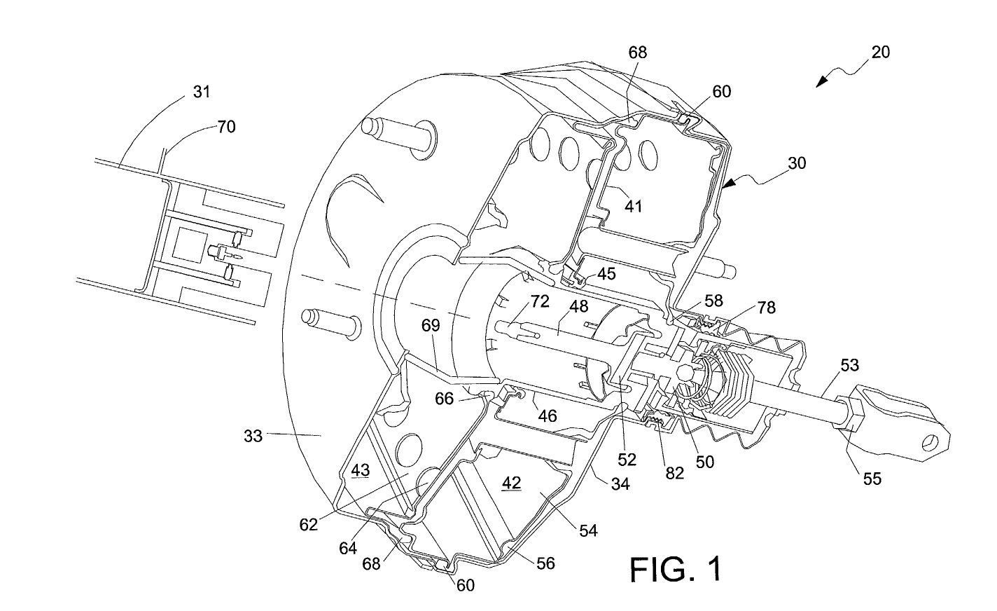

FIG. 1 shows a power brake assembly 20 according to the present invention. The power brake assembly 20 includes a power booster 30 and a master cylinder 31 supported therewith. Power booster 30 has a substantially open internal cavity formed by mating a front housing section 33 and a rear housing section 34. In a preferred embodiment, the power booster 30 is a tandem booster such that a housing divider wall 41 separates the internal cavity into primary and secondary chambers 42 and 43, respectively.

Housing divider wall 41 includes an inner edge that carries an annular seal 45. A secondary portion 46 of a power piston extends through the annular seal 45, and is slidable forwardly and rearwardly to actuate the master cylinder 31 through an output rod 48. The annular seal 45 acts as a bearing for supporting the secondary portion 46 of the power piston in the lateral direction. The secondary portion 46 of the power piston is engageble with a primary portion 50 of the power piston through a rubber reaction disk 52, while the primary portion of the power piston engages a push rod 53 that is axially adjustable with a nut 55. The push rod 53 in turn is engaged with a brake pedal (not shown).

A primary support wall 54 supports a primary diaphragm 56. The primary diaphragm 56 includes an integral inner annular seal 58 that engages the rear of the power piston 46, and an integral outer annular seal 60 that engages housing divider wall 41 and the rear housing section 34. The primary diaphragm 56 separates primary chamber 42 into a variable pressure compartment and a vacuum compartment. Similarly, a secondary support wall 62 supports secondary diaphragm 64. The secondary diaphragm 64 includes an integral inner annular seal 66 that engages the front of the secondary piston 46, and an integral outer annular seal 68 that engages the housing divider wall 41 and the front housing section 33. The secondary diaphragm 64 separates secondary chamber 43 into variable pressure and vacuum compartments similar to those defined by the primary diaphragm 56.

As is well known, a vacuum pressure is generated, by engine intake vacuum or by a supplementary source, in the primary and secondary vacuum compartments when the push rod 53 is actuated. A variable pressure developed in the associated variable pressure compartments by the introduction of atmospheric air through an air valve selectively creates a force on the respective diaphragms 56 and 64, which the support walls 54 and 62 then apply to the power piston 46. In response, the power piston 46 compresses a return spring 69, and the output rod 48 applies force to the master cylinder 31.

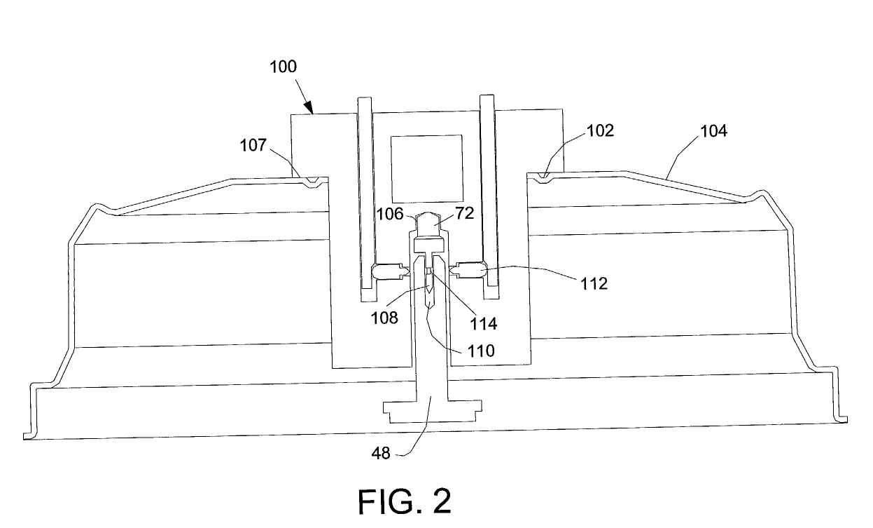

A cap 72 on the end of the output rod 48 engages a master cylinder primary piston, which engages a seal to cover a bypass hole 70 in the master cylinder 31 during brake application. FIG. 2 shows a method for longitudinally positioning the cap 72 on the end of the output rod 48. A tool 100 has an o-ring 102 that seals against the front of the booster housing 104 with the cap 72 held, preferably magnetically, in a cavity 106. Advantageously, the distance from the rounded end of the cap 72 to the abutment surface 107 of the tool is made equal to the gage dimension of the master cylinder.

A vacuum is then drawn on the booster such that a pointed end of a cap shaft 108 extends into a bore 110 in the end of the output rod 48. This operation leaves a small gap, normally less than about 2 millimeters (mm) and more preferably less than about 1.3 mm, between the underside of the head of the cap 72 and the end of the output rod 48. This gap accommodates any variation in the length of the output rod. The rounded end of the cap 72, however, is relatively precisely located. The cap 72 is then fixed in place relative to the output rod by any well known crimping, staking or rolling operation. This operation is represented schematically by crimping heads 112. In a preferred embodiment, material from the output rod 48 is deformed into an annular groove 114 in the cap shaft.

This unique method of setting the ‘X’ dimension on a vacuum booster and/or adjusting the power brake has several advantages. For instance, the present invention significantly reduces travel loss while the assembly is still in the assembly plant. Additionally, any need to machine the cap 72 may be avoided.

It should be appreciated that the above-described embodiments of this invention are exemplary only. For instance, the present invention is applicable in ordinary boosters as well as in lightweight boosters. Various other improvements and modifications to this invention may occur to those skilled in the art and those improvements and modifications will fall within the scope of this invention as set forth below.

1. A method of positioning a cap on an output rod of a power booster, the method comprising:
holding the cap in a fixed position;
inserting a shaft of the cap into a bore in the output rod; and
fixing the cap relative to the output rod.

2. The method of claim 1 wherein the holding step comprises holding the cap magnetically.

3. The method of claim 1 wherein the holding step comprises holding the cap magnetically within a tool.

4. The method of claim 1 wherein the fixing step comprises crimping the output rod.

5. The method of claim 1 wherein the fixing step comprises crimping the output rod into a groove in the shaft of the cap.

6. The method of claim 1 further comprising drawing a vacuum on the booster prior to fixing the cap relative to the output rod.

7. A method of setting a longitudinal dimension of a power booster, the method comprising:
holding a cap in a fixed position;
inserting a shaft of the cap into a bore in an output rod of the power booster; and
fixing the cap relative to the output rod.

8. The method of claim 7 wherein the holding step comprises holding the cap magnetically.

9. The method of claim 7 wherein the holding step comprises holding the cap magnetically within a tool.

10. The method of claim 7 wherein the fixing step comprises crimping the output rod.

11. The method of claim 7 wherein the fixing step comprises crimping the output rod into a groove in the shaft of the cap.

12. The method of claim 7 further comprising drawing a vacuum on the booster prior to fixing the cap relative to the output rod.

13. A method of positioning a cap on an output rod of a power booster, the method comprising:
holding the cap in a fixed position;
inserting a shaft of the cap into a bore in the output rod while drawing a vacuum on the power booster; and
fixing the cap relative to the output rod.

14. The method of claim 13 wherein the holding step comprises holding the cap magnetically.

15. The method of claim 13 wherein the holding step comprises holding the cap magnetically within a tool.

16. The method of claim 13 wherein the fixing step comprises crimping the output rod.

17. The method of claim 13 wherein the fixing step comprises crimping the output rod into a groove in the shaft of the cap.
